(19) United States
(12) Patent Application Publication
(10) Pub. No.: US 2013/0214615 A1
(43) Pub. Date: Aug. 22, 2013

(54) METHOD FOR COLABORATIVE ENERGY TRANSFER IN A WIRELESS NETWORK AND CORRESPONDING WIRELESS NETWORK

(71) Applicants: Tarik Taleb, Heidelberg (DE); Dominique Dudkowski, Heidelberg (DE)

(72) Inventors: Tarik Taleb, Heidelberg (DE); Dominique Dudkowski, Heidelberg (DE)

(73) Assignee: NEC EUROPE LTD., Heidelberg (DE)

(21) Appl. No.: 13/877,185

(22) PCT Filed: Oct. 1, 2010
(86) PCT No.: PCT/EP2010/006001

§ 371 Date: May 13, 2013

(51) Int. Cl. H02J 17/00

(52) U.S. Cl. CPC H02J 17/00
USPC 307/104

(57) ABSTRACT

For allowing a prolongation of the operation time of individual network elements and/or of the whole network in a simple way a method for operating a wireless network is claimed, wherein the network comprises a number of network elements being configured for wireless communication with each other and for wireless energy transfer from one network element to another network element and wherein energy will be transferred wirelessly from one network element to another network element according to negotiations between the network elements for optimizing a network element's individual and/or network's overall energy budget and/or lifetime. Further, an according network is claimed, preferably for carrying out the above mentioned method.

The present invention relates to a method for operating a wireless network, wherein the network is comprising a number of network elements being configured for wireless communication with each other and for wireless energy transfer from one network element to another network element and wherein energy will be transferred wirelessly from one network element to another network element according to negotiations between the network elements for optimizing a network element's individual and/or network's overall energy budget and/or lifetime.

Further, the present invention relates to a network, wherein the network is comprising a number of network elements being configured for wireless communication with each other and for wireless energy transfer from one network element to another network element and wherein said network elements are comprising means for transferring energy wirelessly from one network element to another network element according to negotiations between the network elements for optimizing a network element's individual and/or network's overall energy budget and/or lifetime.

Methods for operating a wireless network and according networks are known, wherein the network comprises a number of network elements being configured for wireless communication with each other. Further, it is basically assumed that transfer of energy wirelessly between different kinds of electronic devices is known.

Particularly, many types of autonomous electronic devices or network elements, such as cell phones in a mobile communication system, sensor nodes in a wireless sensor network, or mobile robots that form a mobile ad-hoc network, are able to communicate by means of wireless technology. While that technology makes those devices autonomous from a communication perspective, the devices' limited energy budget requires their battery to be recharged or replaced after a finite amount of time. In many closed scenarios, e.g. underwater, wildlife, and military, handling battery budget in these ways may be extremely costly or even infeasible. This fact makes many networks not truly wireless due to their dependence on physical intervention.

Recently, energy harvesting has been proposed as a complementary technology to transform ambient energy forms, e.g. solar, radio waves, and kinetics, into electrical energy consumable by an electronic device, thereby taking the next step towards “true wireless”. However, energy harvesting may improve only a single device's energy budget given that the device is equipped with appropriate harvesting circuitry, and limited to those times when harvesting potential is sufficient at all, e.g. when the device is actually exposed to sunlight in the case of harvesting solar energy. As a consequence, the ability to avoid recharging or replacing a battery is given only in few optimal situations.

### Energy Consumption Optimization

State of the art considers methods that target at increasing a device's energy efficiency by reducing its energy consumption, see D. V. Giang, T. Taleb, K. Hashimoto, N. Kato, and Y. Nemoto, “A fair and lifetime-maximum routing algorithm for wireless sensor networks”, in Proc. IEEE Globecom '07, Washington D.C., USA, December 2007. Previously proposed methods work on various layers, for instance, more energy-efficient electronic circuits—see T. Otsuji, Y. M. Meziani, T. Nishimura, T. Suemitsu, W. Knap, E. Sano, T. Asano and V. V. Popov, “Emission of terahertz radiation from dual grating gate plasmon-resonant emitters fabricated with InGaP/InGaAs/GaAs material systems,” J. Phys.: Condens. Matter 20 (2008) 384206 (11 pp)—and network protocols—see the first mentioned reference—are designed at the hardware and network/transport layer, respectively. Other investigations focus on developing batteries with higher capacity. In the context of small electronic devices, the de-facto constraint of such battery technologies is the small required size, placing upper limits on the batteries' performance. In all approaches that optimize energy consumption, a device's energy budget is always limited and can only be replenished by recharging or replacing the battery.

### Energy Harvesting, Energy Scavenging

Energy harvesting or energy scavenging technologies tap into external energy sources, such as sunlight, sound, and kinetics, and convert these forms of energy into electrical energy that can be used to increase the overall energy capacity of individual electronic devices. Research and development in this area focuses on improving energy harvesting technologies and on finding ways to tap into new forms of raw energy. For instance, in C. Alippi and C. Galperti, “An adaptive system for optimal solar energy harvesting in wireless sensor network nodes”, IEEE Trans. Circuits and Systems, Vol. 55, No. 6, July 2008, the authors devise a circuit that maximizes the harvesting of solar energy even under poor weather conditions.

State of the art research also targets at optimizing task placement based on the harvesting potential of autonomous nodes. In A. Kansal and M. Srivastava: An Environmental Energy Harvesting Framework for Sensor Networks. CENS Technical Report, Center for Embedded Network Sensing (CENS), January 2003, the authors devise a distributed framework for sensor networks that i) adaptively learns the spatio-temporal properties of the energy supply across the deployment terrain, ii) shares the learnt information, and iii) gives localized scheduling algorithms for task allotment among nodes based on the detailed characteristics of environmental energy availability. The envisioned tasks can be load balancing, leader elections for clustering purposes, and energy aware communications. The main rational behind this is that the system lifetime can be increased by modifying the task allotment according to the energy available at network nodes.

A combination of energy harvesting and recharging the battery of sensor nodes is considered in M. Rahimi, H. Shah, G. S. Sukhatme, H. Heideman, and D. Estrin, “Studying the feasibility of energy harvesting in a mobile sensor network”, in which the authors propose to instruct mobile robots to move to particular locations where they harvest solar energy, recharge, and then deliver that energy to static sensor nodes that are placed in areas where they are not exposed well to solar light.

While energy harvesting is worthwhile to be considered under stable environmental conditions where the harvesting potential is sufficiently large, it is restricted to individual devices and highly dependent on the availability of raw energy sources. Single nodes that do not possess harvesting potential or that are located in a place where harvesting is not possible due to the unavailability of suitable raw energy sources must manage with available battery capacity, or revert to the recharging or replacement of their battery, as in M. Rahimi, H. Shah, G. S. Sukhatme, H. Heideman, and D. Estrin, “Studying the feasibility of energy harvesting in a mobile sensor network”, in Proceedings of the IEEE International Conference on Robotics and Automation, Taipei, Taiwan, September 2003.

With energy harvesting in place the problem remains that the overall energy capacity of all devices in a communication network is not available in a sufficiently flexible way to be used wherever in the network it may be required.

### Wireless Energy Transfer

More recently, wireless energy transmission technology has become available for the purpose of recharging certain kinds of electronic devices. For that purpose, near-field wireless energy transfer technology is used, such as in Chun-Kil Jung: Wireless power charging system. United States Patent Application Publication US 2009/0140690 A1, Jun. 4, 2009, which no longer requires a device to be plugged into a power outlet. In this setup, manually placing the mobile device close to the wireless charging station is still required, which adds some additional convenience by the avoidance of cabling. Near-field wireless energy transfer is not suitable for the network scenarios we consider, such as wireless sensor network and mobile robot scenarios.

State of the art also considers extending the idea of wireless energy transfer to far-field transfer, in which energy is wirelessly transferred over relatively long distances, e.g. 10-20 meters, sometimes referred to as WiTricity. A selection of related proposed technologies for far-field transfer is the ultrasound transmission used in Arthur Charych: System and method for wireless electrical power transmission. U.S. Pat. No. 6,798,716, Sep. 28, 2004, and the wireless energy transfer via electromagnetic waves between a pair of devices in Gunjan Porwal: Wireless energy transfer, United States Patent Application Publication US 2009/0108679 A1, Publication Date Apr. 30, 2009. Methods for remote recharging of e.g. cell-phones and sensor nodes are considered by Nokia, see Nokia getting energy off the air, from existing EM transmission, and Powercast, see True wireless power by Powercast http://www.powercastco.com/, respectively, the former harvesting energy from ambient radio waves to increase a cell phone's energy. The term “WiTricity hotspots” is used in the state of the art to refer to the vision of base stations that are capable of providing wireless energy charging services to mobile devices.

While described technologies show that it is feasible to transfer energy wirelessly in the order of microwatt and milliwatt quantities of electrical power over significant distances, all proposed ideas assume a single-device view, which makes all solutions device-centric.

Thus, it is an object of the present invention to improve and further develop a method for operating a wireless network and an according network for allowing a prolongation of the operation time of individual network elements and/or of the whole network in a simple way.

In accordance with the invention, the aforementioned object is accomplished by a method comprising the features of claim 1 and by a network comprising the features of claim 22.

According to the invention it has been recognized that known technology with regard to communication and wireless energy transfer between network elements can be used for optimizing the energy budget and/or lifetime of autonomous network elements and/or of the whole network. Concretely, energy will be transferred wirelessly from one network element to another network element according to negotiations between the network elements for optimizing the energy budget and/or lifetime. State of the art completely lacks the idea of such negotiations between the network elements. Therefore, based on the invention a prolongation of the operation time of individual network elements and/or of the whole network is possible in a simple way.

Preferably, the negotiations could be performed collaboratively between members of a group of definable network elements or between all network elements. State of the art completely lacks the idea of considering collaborative wireless energy capacity negotiations between the network elements themselves. By means of collaborative negotiations the energy capacities of individual network elements can be considered with regard to the wireless transfer of energy from one network element to another network element.

Within a preferred embodiment said optimizing could comprise a balancing of energy available within the overall network or within a part of the network, the part being defined by some collaborating network elements, between some predefinable or all network elements. By means of such a balancing of energy a network element comprising a high energy capacity could transfer a part of its energy to a network element with low energy capacity so that both network elements could perform their necessary tasks without energy capacity problems.

Preferably, said optimizing could be performed under a network load that is generated by computing and/or communication and/or sensing tasks. Thus, the optimizing procedure could be based on a real application scenario.

Concretely, an energy pool could be created within the network for providing energy to all network elements which need energy, wherein the energy pool could be filled with energy by network elements which comprise a high energy capacity or a lot of energy or wherein the energy pool could consist of network elements which comprise high energy capacity.

Within a preferred embodiment the energy pool could comprise available energy of some definable or of all network elements. Definable network elements could be network elements which have a high energy capacity or high energy resources. In this case, network elements with low energy resources or without excess resources are not obligated to provide energy for the energy pool.

Within a further preferred embodiment energy could be transferred to a network element which urgently needs energy for enhancing its lifetime or a lifetime of the network and/or for fulfilling a predefinable task. Thus, the risk of failure of the network element is avoided.

Depending on an individual situation the energy could be transferred to the network element via at least one other network element. By such a transfer via at least one other network element energy could be also transferred to network elements which are situated at a distance which is not reachable by a direct transfer of energy between only two network elements.

Within a further preferred embodiment at least one mobility feature of at least one network element could be taken into account to estimate when network elements that are suitable for performing energy transfer are close enough in geographic terms for transferring energy at an effective magnitude. In other words, the energy transfer could be performed at predefinable points in time and location for providing a very effective energy transfer between the respective network elements.

Preferably, a transfer of energy could be performed synchronously with a data communication. In this situation a very effective transfer of energy is possible, as the respective network elements are already in a communication situation.

Further preferred, a transfer of energy could be performed via the same carrier wave as a data communication. This could result in a very effective energy transfer.

With regard to a very effective prolongation of the operation time of individual network elements and/or of the whole network energy could be harvested by at least one network element by transforming an ambient energy form into electrical energy. By such a harvesting procedure the energy budget of the overall network could be augmented in a very simple way. Concretely, the harvested energy could be provided to the energy pool for providing the harvested energy to network elements which need additional energy.

For simply realizing such an energy harvesting at least some network elements could comprise an energy harvester circuitry. In a very special and simple case at least some of the network elements that comprise an energy harvester circuitry could not comprise a battery. In this case a battery is not absolutely necessary as such a network element could gather its necessary energy by the energy harvester circuitry and/or by the transmission of energy from other network elements or from the energy pool. The provision of energy harvester circuitries could realize very ecologic network elements harvesting energy from ambient energy.

Within a further concrete embodiment at least some network elements could comprise an energy transceiver for wirelessly transmitting and receiving energy in a very simple way.

With regard to a very effective usage of network capacities and thus prolongation of operation time one network element could request another network element to execute a task on its behalf. The selected network element could be a network element which comprises an energy capacity higher than that of the requesting network element.

In another situation the one network element could select—out of definable other network elements—the network element which can harvest the highest amount of energy as the network element which is executing the requested task. Alternatively, the one network element could select the network element which involves a minimum overhead for energy transfer.

Within a further preferred embodiment wireless energy transfer capabilities and/or energy harvesting potential of network elements could be used as a metric in a cluster head selection. For example, the network element with the best energy transfer capabilities and/or the network element with the best harvesting potential could be selected as cluster head.

With regard to an optimized energy balancing among the network elements via energy transfer said optimizing could consider mobility characteristics and/or wireless energy transfer capabilities and/or energy harvesting potential of the network elements, preferably for minimizing transfer overhead and maximizing energy harvesting at the same time in order to converge to a uniform energy distribution between the network elements.

Within a preferred embodiment an energy pooling or an energy pooling system could be realized in a distributed form, i.e. in the form of a communications protocol that is executed between network elements that participate in the energy pool and by which energy transfer decisions are made and executed.

Further preferred, an energy pooling or an energy pooling strategy could be realized centrally in the form of a centralized service with which network elements interact via a communications protocol and inform the service about the current status of the energy pool such that the service can determine which energy transfers are to be executed in the energy pool, the decision being notified to the affected network elements and executed by the network elements.

Within a further preferred combined way an energy pooling or an energy pooling strategy could be realized in a hybrid form that combines distributed and centralized realizations according to the above mentioned centralized and distributed forms to realize a partly centralized and partly distributed energy pooling strategy. Such a hybrid form could provide a very flexible network or system which could be adapted to different individual scenarios.

The present invention proposes to exploit wireless energy transfer technology for balancing energy between network elements. It is possible to create an “energy pool” in a network of autonomous electronic network elements such as those in mobile communications, wireless sensor networks, and mobile autonomous robot scenarios. Based on such an energy pool the invention proposes to optimize the network's overall energy budget by transferring energy between autonomous network elements to whichever network elements that may be in urgent need of energy to optimize the overall network's lifetime or to assist the network elements to carry out their tasks. Such energy pooling could be also used to promote cooperation among network elements.

This invention further proposes to consider energy harvesting as a complementary technology in order to increase the energy budget of individual network elements and as a result the capacity of the whole network's energy pool or energy budget. By means of wireless energy transfer technology, individually harvested energy can also be transferred between autonomous network elements to further increase the lifetime of the network as a whole, and as a corollary, decrease or completely avoid the recharging or replacement of any of the batteries of the network elements.

The invention is providing a system for collaboratively pooling energy in a network of autonomous network elements by means of technology that enables wireless energy transfer. A prolongation of the network lifetime by balancing available energy in the network's energy pool between collaborating network elements is the result.

For instance, it is desirable to use available energy in a highly charged network element that also possesses good harvesting potential for the sake of supporting another network element that is about to run out of energy and that cannot harvest, thereby optimizing an individual network element's energy budget and/or further improving the network's lifetime. Flexible energy distribution mechanisms that support such forms of “energy pooling”, however, are currently not considered in the state of the art.

The network elements collaborate via wireless communication with the objective to optimize the energy budget and to prolong the lifetime of the network elements and/or of the network. In other words, the collaborating network elements negotiate the wireless transfer of energy for optimizing the energy budgets of the network elements and/or of the network. The incorporation of energy harvesting technology by a possible sharing and injection of the harvested energy into a collaboratively formed energy pool further prolongs the lifetime of the network elements and/or of the network.

There are several ways how to design and further develop the teaching of the present invention in an advantageous way. To this end it is to be referred to the patent claims subordinate to patent claim 1 on the one hand and to the following explanation of preferred examples of embodiments of the invention, illustrated by the drawing on the other hand. In connection with the explanation of the preferred embodiments of the invention by the aid of a drawing, generally preferred embodiments and further developments of the teaching will we explained. In the drawing

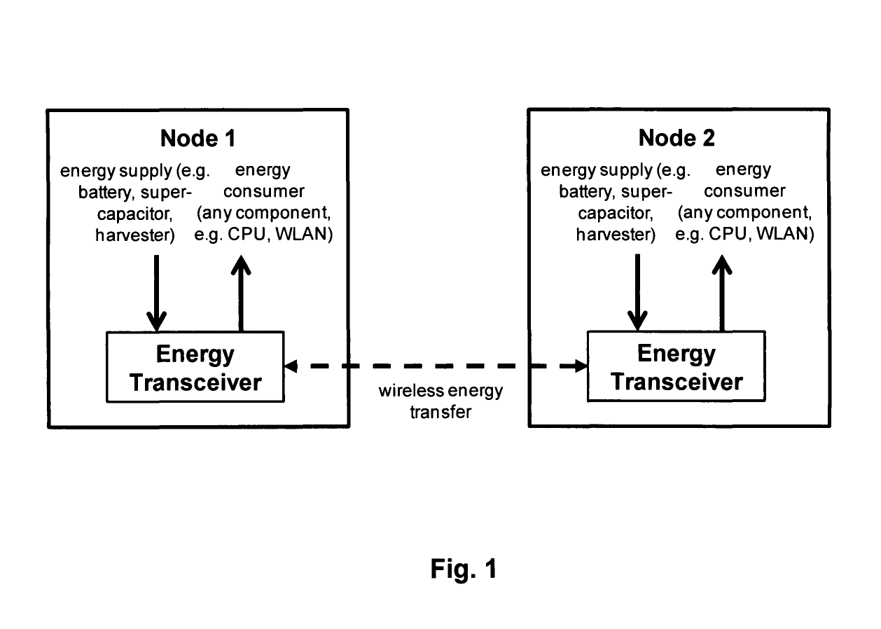

FIG. 1 is showing two network elements being equipped according to an embodiment of the invention,

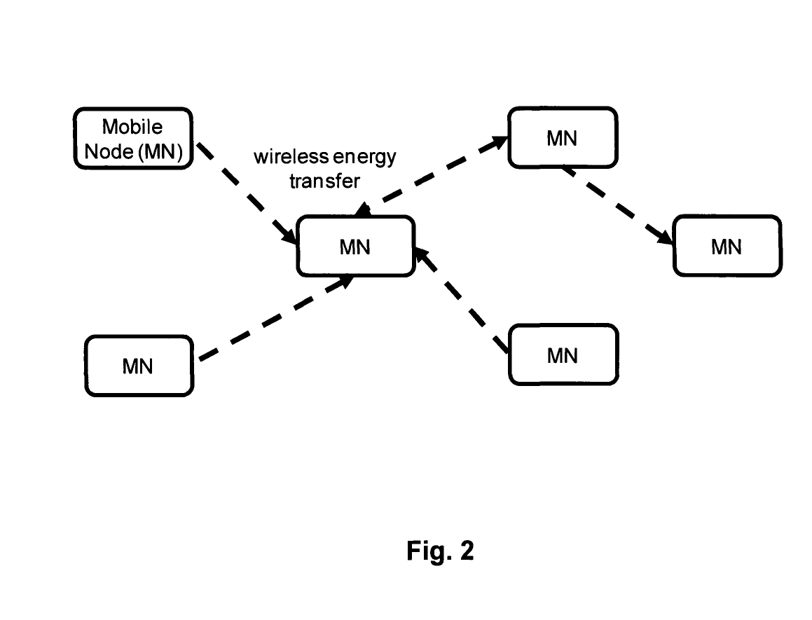

FIG. 2 is showing an embodiment of a network arrangement comprising wireless network elements,

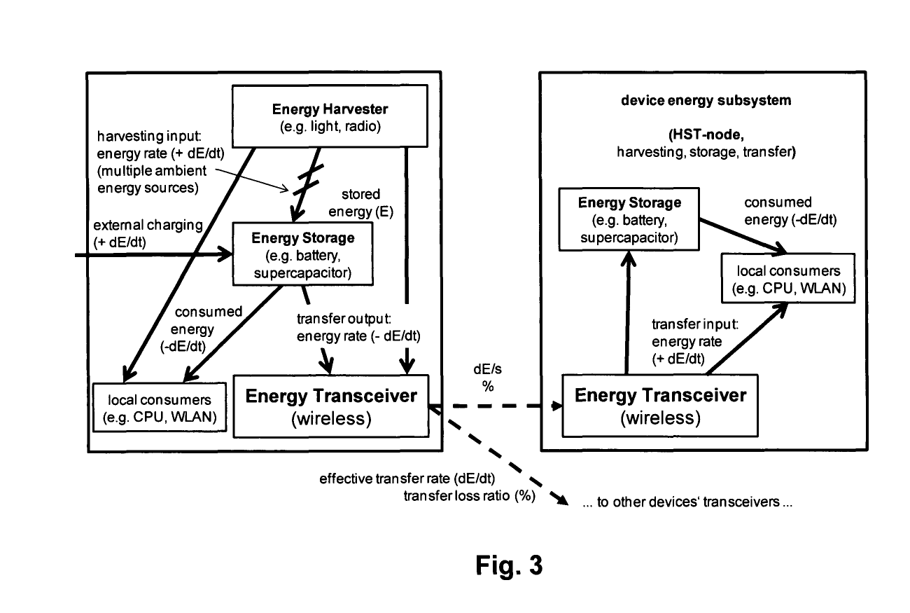

FIG. 3 is showing an extended energy Harvesting-Storage-Transfer (HST) model according to a further embodiment of the invention and

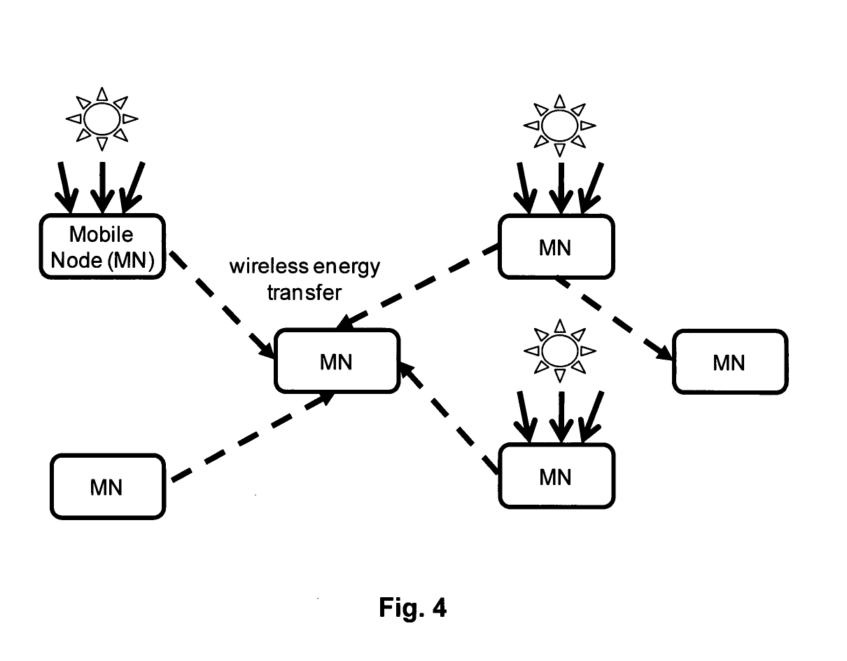

FIG. 4 is showing collaboratively working wireless network elements with partially energy harvesting support.

FIG. 1 is showing a basic system according to an embodiment of the invention. A network element in the form of a node is equipped with an energy transceiver, which is able to “send” and “receive” energy by wireless means from/to other network elements or nodes, using any of the potentially available wireless energy transfer technologies. Energy is supplied to the energy transceiver e.g. via battery, capacitors, or energy harvesters. Energy received from the energy transceiver is used by any energy consumer of the node, e.g. any component such as CPU, WLAN, or stored in the battery of the node.

It is important to note that wireless energy transfer is generally associated with a loss while it is being transferred between nodes. For example, assume a network consisting of two network elements or nodes, N1 and N2, with an energy budget X and Y, respectively. Assume further that N2 is in need of additional energy, which can be transferred to it from N1, and that N2 will get Epsilon additional energy, and that N1 will lose Gamma energy. The overall energy budget of the network before wireless energy transfer is (X+Y). The network's overall energy budget after energy transfer is (X−Gamma)+(Y+Epsilon). Due to loss during wireless energy transfer, it generally holds that (X+Y)>(X+Y−Gamma+Epsilon), that is, Gamma>Epsilon. Hence, any wireless energy transfer, if not compensated, decreases the network's overall energy capacity, while an individual node's energy budget can also be increased.

FIG. 2 depicts a wireless network composed of a multitude of network elements or nodes that each possesses an energy transceiver in the form of any conceivable wireless energy transfer capability. Energy is transferred wirelessly between pairs of nodes and also over multiple hops to more distant nodes, as indicated by the arrows.

### Method and Network Details

The general system or network considers that each network element in the form of a node in the network consumes energy due to the execution of some task related to computing, communications, or sensing. With the dynamics of executed tasks, the energy consumption is also changing. Each node can, at any time, be characterized by its residual energy capacity, which can be positive if the node has energy storage capabilities (e.g. a battery), or zero if the node cannot store energy but only obtain it instantaneously, most of all, via energy transfer. Note that a value of zero for a node's residual energy is a theoretical value that in the general case—with some possible exceptions—should be avoided in a real system to guarantee that the node has at least some minimum operational capabilities.

In the most general setup, the instantaneous power required by each node in the network to perform its tasks and the energy budget available at each network node is sufficient to decide how energy may be transferred such that the energy budget of an individual node and/or that of the overall network is optimized. For instance, if a node is low on energy, it can negotiate with adjacent nodes to receive energy from these nodes via energy transfer capabilities, such that its lifetime can be sufficiently prolonged to achieve a prolongation of the overall network's lifetime.

Because any energy transfer involves a loss of energy as described previously, any single transfer or more complex transfer patterns between multiple nodes must be preceded with calculations that perform tradeoff calculations. For example, a calculation may determine that it is sufficiently beneficial to transfer energy from a node to another adjacent node—via a single hop—but not via multiple hops due to an aggregated energy loss via multiple hops that does not allow the transfer of a sufficient amount of energy anymore.

In mobile networks, mobility can be taken into account to estimate when nodes that are suitable for performing mutual—or group-level—energy transfer are close enough in geographic terms such that they are able to transfer energy wirelessly at a sufficiently effective magnitude. In such a case the best spot in time can be anticipated at which energy will be transferred, such as the time when the nodes are expected to be closest before they move away from each other again.

A specific feature is the consideration of energy transfer that is synchronous with data communications. In this setup, during data communication that occurs via radio, energy can be transferred simultaneously via the same carrier wave, and captured by the receiving device or network element.

### Energy Harvesting Support

As an extension of the claimed method and network, FIG. 3 shows a more detailed internal structure of an electronic network element that besides an energy transceiver is also equipped with energy harvester circuitry. Arrows indicate flow of energy, where some of the flows can be optional. In one preferred embodiment, the network element does not have a battery, in which case harvested energy is directly consumed by the node or used by the transceiver to power adjacent nodes. It is also possible that external charging of battery is supported, that energy becoming available for wireless energy transfer once the network element enters the scenario again, e.g. when a sensor node is redeployed in an environmental monitoring scenario.

FIG. 4 shows a modification of FIG. 2 where energy harvesting capabilities are available to a subset of network elements, the energy being made available to the network's overall energy pool via wireless transfer technology. As described previously, wireless energy transfer always incurs a loss of energy. Harvesting is an important part of the system or network that is able to compensate energy loss due to wireless energy transfer. In general, harvested energy will increase the overall energy budget available in the network, or, under heavy network loads—sensing, computing, communication—will prolong the network's lifetime further.

### FURTHER EMBODIMENTS

The above mentioned approach can be applied in different scenarios such as the following ones:

### 1. Partner Selection for Cooperative Communication Based on a Peer's or Network Element's Energy Harvesting/Transfer Potential

In cooperative communication, a mobile network element can request another mobile network element to execute a task, e.g., handover initiation, data relaying, etc., on its behalf. The main limitation in cooperative communication pertains to energy: Users do not want to “waste” their energy to execute “unprofitable” operations on behalf of others. Wireless energy transfer in combination with energy harvesting could help here as follows.

For example, let us assume that Task A1 will require energy B1 from a partner P. The same partner is in a location that will enable it to harvest energy B2. Partner P is willing to perform Task A1 on behalf of the requesting network element provided that the terminal transfers to P a B3 amount of energy, i.e., cooperation fee. Intuitively, B3 can be a fraction of B1, and the higher B2 is, the smaller the fraction is. In such scenario, the terminal could select as partner—out of many available terminals—the partner that can harvest maximum amount of energy, requests smallest amount of energy as compensation, and involves minimum overhead for energy transfer.

### 2. Cluster Head Selection Based on Amount of Energy to Share With Other Network Elements or Nodes

There are already many cluster head selection strategies in the literature, e.g., based on topological location of network elements or nodes, performance capabilities of network elements or nodes, etc. Wireless energy transfer capabilities and/or energy harvesting potential could be also considered as metrics in cluster head selection. For example, the network element or node with the best energy transfer capabilities and/or the network element or node with the best harvesting potential is selected as cluster head.

### 3. Energy Balancing Among Mobile Network Elements or Nodes Via Energy Transfer

One way to optimize/maximize the lifetime of a network is to combine mobility features of network elements or nodes, their wireless energy transfer capabilities, and their energy harvesting potential in a way that minimizes transfer overhead and maximizes harvesting at the same time in order to converge fast on uniform energy distribution.

### 4. Mobile Network Element Selection Based on Energy Transfer/Harvesting

The selection of network elements can also be optimized based on wireless energy transfer/harvesting. For example, a mobile network element is interested in receiving data contents, e.g., video, available at N mobile network elements simultaneously from a set of the N mobile network elements. The terminal requests a centralized entity/server for guidance on which mobile network elements to receive data from. For example, guidance can be in the form of an ordered list of the N mobile network elements based on the energy budget of the mobile network elements (including the energy to be harvested) and/or the E2E (End-to-End) path between the mobile network elements. Alternatively, the mobile network element prioritizes the N mobile network elements based on the energy budget each has/can harvest if relevant information is exchanged. As in order to send data to a network element, network elements have to use some of their energies, they may request compensation from the network element. In such case, network elements to which energy can be wirelessly transferred with the minimum overhead can be selected.

### Important Aspects

1) Exploitation of wireless energy transfer technology to create a pool of energy in a network of autonomous electronic network elements, where the network elements collaborate via wireless communication with the objective to assist network elements in urgent need of energy to execute their operations, to increase individual network element's energy budget, and/or to optimize the network's overall energy budget/lifetime given a network under load consuming energy due to computing, communication, and sensing.
2) Consideration of energy harvesting potential of individual network elements to tap into ambient energy sources in order to augment the energy pool of a network of autonomous network elements and making the harvested energy of individual network elements available to all other network elements in the network, mainly those less fortunate in terms of energy harvesting capabilities.

Based on the present invention it is possible to increase lifetime of individual network elements by drawing energy from the energy pool that is formed by the energy budgets or capacities of all network elements in the network. Further, it is possible to increase the overall network lifetime by energy pooling across the complete network in such a way that lifetime-critical functions can be maintained. According to another aspect energy harvesting can be made available via the network-wide energy pool to other network elements in contrast to network element-specific harvesting only.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for operating a wireless network, wherein the network is comprising a number of network elements being configured for wireless communication with each other and for wireless energy transfer from one network element to another network element and wherein energy will be transferred wirelessly from one network element to another network element according to negotiations between the network elements for optimizing a network element's individual and/or network's overall energy budget and/or lifetime.

2. A method according to claim 1, wherein the negotiations will be performed collaboratively between members of a group of definable network elements.

3. A method according to claim 1, wherein the negotiations will be performed collaboratively between all network elements.

4. A method according to claim 1, wherein said optimizing is comprising a balancing of energy available within the overall network or within a part of the network, the part being defined by some collaborating network elements, between some predefinable or all network elements.

5. A method according to claim 1, wherein said optimizing will be performed under a network load that is generated by computing and/or communication and/or sensing tasks.

6. A method according to claim 1, wherein an energy pool will be created within the network.

7. A method according to claim 6, wherein the energy pool comprises available energy of some definable or of all network elements.

8. A method according to claim 1, wherein energy will be transferred to a network element which urgently needs energy for enhancing its lifetime or a lifetime of the network and/or for fulfilling a predefinable task.

9. A method according to claim 1, wherein the energy will be transferred to the network element via at least one other network element.

10. A method according to claim 1, wherein at least one mobility feature of at least one network element will be taken into account to estimate when network elements that are suitable for performing energy transfer are close enough in geographic terms for transferring energy at an effective magnitude.

11. A method according to claim 1, wherein a transfer of energy will be performed synchronously with a data communication.

12. A method according to claim 1, wherein a transfer of energy will be performed via the same carrier wave as a data communication.

13. A method according to claim 1, wherein energy will be harvested by at least one network element by transforming an ambient energy form into electrical energy.

14. A method according to claim 13, wherein harvested energy will be provided to the energy pool.

15. A method according to claim 13, wherein at least some network elements comprise an energy harvester circuitry.

16. A method according to claim 15, wherein at least some of the network elements that comprise an energy harvester circuitry do not include a battery.

17. A method according to claim 1, wherein at least some network elements comprise an energy transceiver for wirelessly transmitting and receiving energy.

18. A method according to claim 1, wherein one network element is requesting another network element to execute a task on its behalf.

19. A method according to claim 18, wherein the one network element is selecting—out of definable other network elements—the network element which can harvest the highest amount of energy as the network element which is executing the requested task.

20. A method according to claim 1, wherein wireless energy transfer capabilities and/or energy harvesting potential of network elements will be used as a metric in a cluster head selection.

21. A method according to claim 1, wherein said optimizing considers mobility characteristics and/or wireless energy transfer capabilities and/or energy harvesting potential of the network elements, preferably for minimizing transfer overhead and maximizing energy harvesting at the same time in order to converge to a uniform energy distribution between the network elements.

22. A network, preferably for carrying out the method for operating a wireless network according to claim 1, wherein the network is comprising a number of network elements being configured for wireless communication with each other and for wireless energy transfer from one network element to another network element and wherein said network elements are comprising means for transferring energy wirelessly from one network element to another network element according to negotiations between the network elements for optimizing a network element's individual and/or network's overall energy budget and/or lifetime.

23. A network according to claim 22, wherein an energy pooling or an energy pooling system is realized distributed in the form of a communications protocol that is executed between network elements that participate in the energy pool and by which energy transfer decisions are made and executed.

24. A network according to claim 23, wherein an energy pooling or an energy pooling strategy is realized centrally in the form of a centralized service with which network elements interact via a communications protocol and inform the service about the current status of the energy pool such that the service can determine which energy transfers are to be executed in the energy pool, the decisions being notified to the affected network elements and executed by the network elements.

25. A network according to claim 24, wherein an energy pooling or an energy pooling strategy is realized in a hybrid form that combines distributed and centralized realizations to realize a partly centralized and partly distributed energy pooling strategy.

26. A network according to claim 22, wherein an energy pooling or an energy pooling strategy is realized centrally in the form of a centralized service with which network elements interact via a communications protocol and inform the service about the current status of the energy pool such that the service can determine which energy transfers are to be executed in the energy pool, the decisions being notified to the affected network elements and executed by the network elements.
